(19) United States
(12) Patent Application Publication
(10) Pub. No.: US 2015/0148018 A1
(43) Pub. Date: May 28, 2015

(54) VEHICLE OPERATOR SPECIFIC USER DEVICE MANAGEMENT

(71) Applicant: Lenovo (Singapore) Pte. Ltd., Singapore (SG)

(72) Inventors: Amy Leigh Rose, Chapel Hill, NC (US); John Scott Crowe, Durham, NC (US); James C. Loebach, Raleigh, NC (US); Nathan J. Peterson, Durham, NC (US)

(73) Assignee: Lenovo (Singapore) Pte. Ltd., Singapore (SG)

(21) Appl. No.: 14/089,818

(22) Filed: Nov. 26, 2013

(51) Int. Cl. H04M 1/725; H04W 4/04

(52) U.S. Cl. CPC H04M 1/72577; H04W 4/046
USPC 455/418

(57) ABSTRACT

An embodiment provides a method, including: detecting, in a vehicle, a user device is proximate to a receiver device of the vehicle; determining, using a processor, that the user device is associated with a current operator of the vehicle; permitting access to the vehicle; and disabling a communication capability of the user device. Other aspects are described and claimed.

### BACKGROUND

Texting while driving is an important safety issue which has gained attention because of the number of vehicle accidents caused, at least in part, by such activity. Many jurisdictions have moved towards banning this practice altogether or curbing it substantially.

With the proliferation of mobile user devices, e.g., smart phones, tablet devices, e-readers, etc., some of which are specifically designed for use in a vehicle, e.g., personal navigation systems, etc., determining which types of communications during vehicle use are acceptable, if any, has been an ongoing challenge. Moreover, many devices, e.g., smart phones, now support a multitude of capabilities, some of which are undesirable for use while operating a vehicle, e.g., text messaging capabilities, while other capabilities may be more suitable in some contexts, e.g., hands free wireless telephone capability, navigation capabilities, etc.

### BRIEF SUMMARY

In summary, one aspect provides a method, comprising: detecting, in a vehicle, a user device is proximate to a receiver device of the vehicle; determining, using a processor, that the user device is associated with a current operator of the vehicle; permitting access to the vehicle; and disabling a communication capability of the user device.

Another aspect provides a vehicle, comprising: a vehicle body; a motor to propel the vehicle body; a receiver device disposed within the vehicle body; a processor; and a memory device storing instructions executable by the processor to: detect a user device is proximate to the receiver device; determine that the user device is associated with a current operator of the vehicle; permit access to the vehicle; and disable a communication capability of the user device.

A further aspect provides a program product, comprising: a storage medium comprising computer readable program code, the computer readable program code comprising: computer readable program code configured to detect, in a vehicle, a user device is proximate to a receiver device of the vehicle; computer readable program code configured to determine, using a processor, that the user device is associated with a current operator of the vehicle; computer readable program code configured to permit access to the vehicle; and computer readable program code configured to disable a communication capability of the user device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example interior of a vehicle and mobile user devices therein.

FIG. 4 illustrates an example method for vehicle operator specific user device management.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

While the improvements to mobile user devices, e.g., smart phones, tablets, navigation systems, laptops, etc., has lead to a great expansion in these devices' capabilities, challenges have also been introduced. For example, many of these devices' capabilities are incompatible with safety in certain contexts. By way of example, while texting with friends or other contacts while sitting in a café is acceptable, doing so while driving an automobile is not.

In an example case, a driver of an automobile may be distracted by such devices if they are permitted to be used by the driver while the driver attempts to perform driving duties. Thus, such devices are often not amendable to the safe operation of the vehicle. Prior approaches to reducing or preventing such unsafe behavior have been, generally speaking, directed at eliminating certain types of communication capabilities. For example, a conventional solution is to prevent all mobile user devices within an automobile from utilizing text messaging capabilities. However, such approaches take an overly broad approach to facilitating a safe driving environment, as other users (passengers) may well want to utilize their devices.

Accordingly, an embodiment provides an operator specific approach to limiting mobile user device capabilities. An embodiment prohibits an operator's user device, e.g., the smart phone of the current driver of the automobile, from utilizing certain communication capabilities, e.g., SMS text messaging capabilities, while permitting other mobile user devices to operate freely. Thus, others, e.g., passengers in an automobile, will continue to be able to utilize their mobile user devices, whereas the operator will not. By providing an operator specific limitation on communication capabilities of a mobile user device, an embodiment permits the operator to focus on operating the vehicle while letting remaining device users operate their devices in an unencumbered fashion.

The illustrated example embodiments will be best understood by reference to the figures. The following description is intended only by way of example, and simply illustrates certain example embodiments.

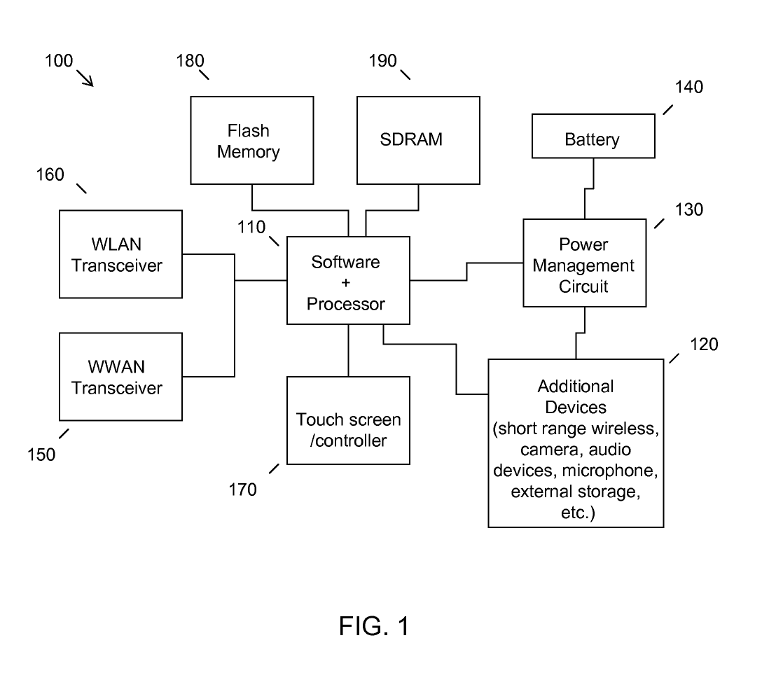

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a short range wireless communication device, such as a BLUETOOTH radio, or element(s) that may be used for near field communications. Commonly, system 100 will include a touch screen 170 for data input and display. System 100 also typically includes various memory devices, for example flash memory 180 and SDRAM 190.

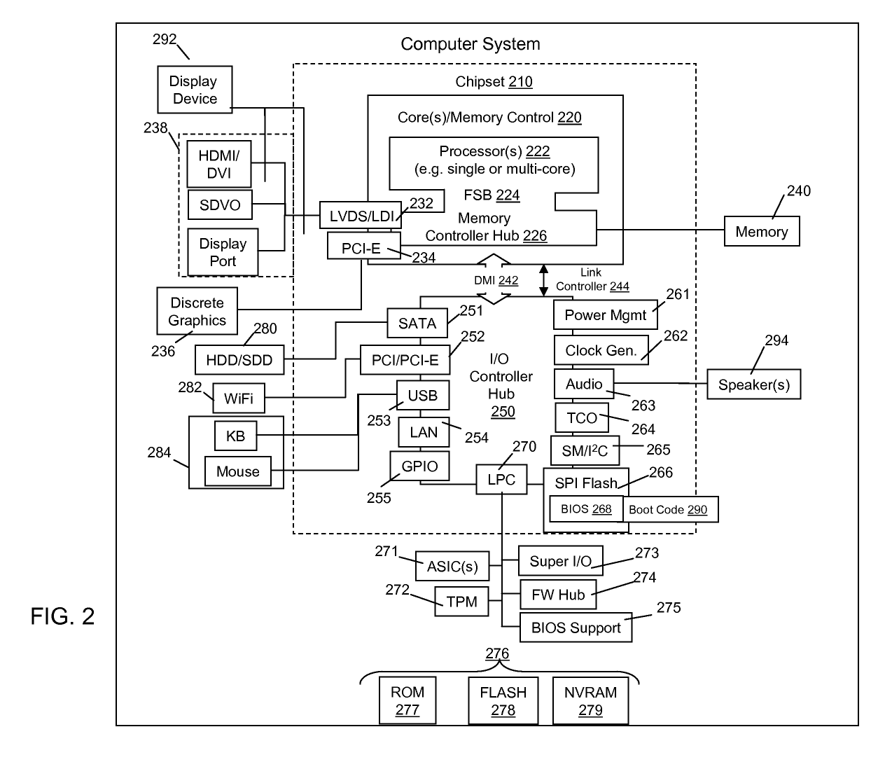

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280 et cetera), a PCI-E interface 252 (for example, for wireless connections 282), a USB interface 253 (for example, for devices 284 such as a digitizer, keyboard, mice, cameras, phones, microphones, storage, other connected devices, et cetera), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be utilized in various devices according to the embodiments described herein. For example, the circuitry outlined in FIG. 1 may be used in smart phone or tablet computing device, the circuitry outlined in FIG. 2 may be used in a vehicle on-board computer, etc.

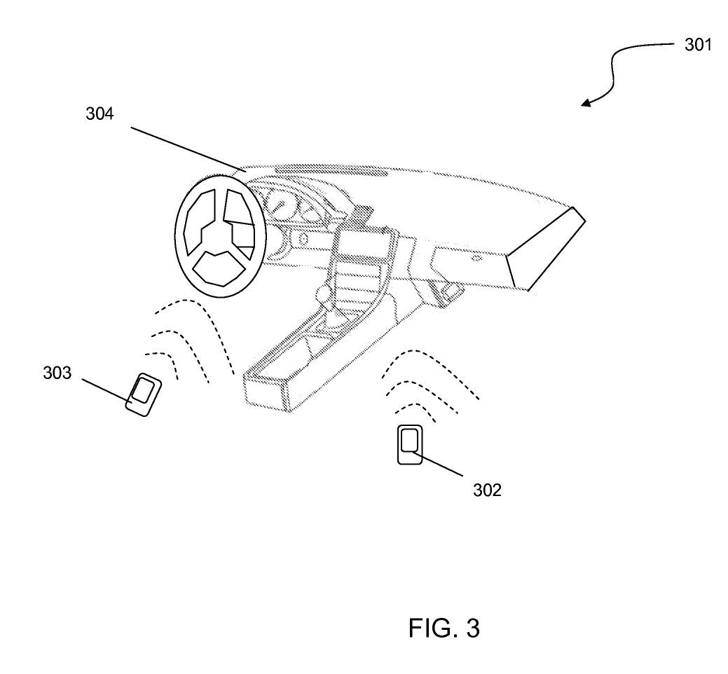

In FIG. 3 an interior of a vehicle 301 is illustrated. The vehicle interior 301 accommodates various occupants, e.g., a driver and a passenger. In an embodiment, an operator specific management of a user device, e.g., 303, is implemented for various functionalities. For example, an operator's user device 303 may be used to start the vehicle, e.g., activate the ignition system, but not to send text messages. An embodiment also permits the use of other user devices, e.g., a passenger user device 302, as further described herein.

An embodiment allows for distinguishing a user device as either associated with the current operator of the vehicle or not associated with the current operator of the vehicle. Thus, an embodiment may selectively disable certain capabilities of the current operator's device, whereas the other user devices may be left unaltered.

For example, as illustrated in FIG. 3, an operator's user device 303 and a passenger's user device 302 are in different physical locations. That is, an operator's user device is located with the operator, i.e., within a left-front zone of the vehicle interior 301. In contrast, the passenger's user device, 302, is located in an upper-right zone of the vehicle interior 301. Thus, an embodiment may distinguish between the current operator's use device 303 and another, e.g., passenger, user device 302 based on device location.

Device location may be determined in a variety of ways. For example, a proximity metric may be utilized in determining a user device's position. An example proximity metric is signal strength, e.g., as detected by a receiver device 304 located in an area of the vehicle's interior 301. In one example, a receiver device may be positioned on the driver's side of an automobile and another receiver device may be positioned on the passenger's side of the automobile such that the signal strengths of the various mobile devices (e.g., located on the passenger's side and the driver's side) may be compared in order to determine which user device is in which location.

The location of the receiver device 304 may be purposely chosen to facilitate a closer proximity to the operator's user device than another, e.g., passenger, user device 302. In the example illustrated in FIG. 3, the receiver device 304 is located in the upper left corner of the dashboard of the vehicle interior 301. Thus, the receiver device will be proximate to the current operator's user device 303 and distant with respect to the other user device 302. Accordingly, an embodiment may compare the relative signal strengths of the user devices 302, 303 (if both devices 302, 303 are detectable by the receiver) in order to determine which device is associated with the current operator of the vehicle, e.g., user device 303.

In another example, the ability to detect a user device itself may be utilized to determine if the user device is associated with the current operator of the vehicle. For example, a very close proximity, e.g., within a few centimeters, may be required in order for the receiver device 304 to detect the user device, e.g., 303. Thus, a user may be required to tap on the receiver device 304 location with his or her user device 303 in order to have the user device 303 detected by the receiver device 304. This permits the operator's device 303 to be explicitly distinguished from other user devices, e.g., 302, which will not be detected due to the distance between these devices and the receiver device 303. Moreover, a user device's identification may also be communicated using this mechanism, thereby allowing an embodiment to detect a particular user device has been brought into close proximity to the receiver device.

An example of such a close-proximity method is a near field communication (NFC) between the user device, e.g., 303, and the receiver device 304. It should be noted here that “receiver device” is not used to imply a directionality of communication is required. That is, the “receiver device” may in fact transmit information in addition to receiving information, e.g., in the case where the user device being detected is a passive device.

Other mechanisms for associating a user device with a current operator of the vehicle may be utilized. For example, an operator identifier (or a set of operator identifiers) may be stored, e.g., in a memory accessible to the receiver device 304 and associated circuitry. Thus, if the receiver device 304 detects a user device, e.g., device 303, identifying information of the device (e.g., device ID) may be compared to the stored operator identifier (or set of operator identifiers). If there is a match between the identifying information of the user device and a known operator identifier, the user device may be associated with a current operator and have limited communication capabilities implemented, as described herein.

Having associated a user device with a current operator of the vehicle (e.g., automobile), an embodiment may selectively disable certain functionality of the user device so associated. Thus, an embodiment may reduce or limit communication capabilities of the user device of the current operator of the vehicle. In this way, the current operator of the vehicle may be restricted from engaging in certain activities (e.g., SMS text messaging, email communications, web browsing, etc.) or all activities (e.g., the device may be placed in a lower power state).

In an embodiment, a user device may be utilized to open the vehicle door, e.g., after a one-time pairing has been completed between the vehicle and the user device. This may take a variety of forms, for example unlocking the vehicle door(s) in response to a command input by the user on the user device, or for example via automatically unlocking the doors responsive to the user device being brought into proximity to an element (e.g., NFC element) in the vehicle door that permits unlocking or access to the vehicle. Other arrangements may also be utilized, e.g., short range wireless, e.g., BLUETOOTH pairing between the vehicle door and the user device may be utilized to permit access to the vehicle with or without automatic unlocking based on proximity, etc.

In the event the user device (e.g., mobile phone) loses power, an element (e.g., an RFID tag) may also be present within the user device that would only require the car to be powered. The user might, for example, need to hold the mobile device up to the door for access to the vehicle to be permitted. Additionally, similar techniques may be utilized to provide access to the vehicle at other levels, e.g., a user holding the user device up to the “Start Button” or like receiver within a car to start the car.

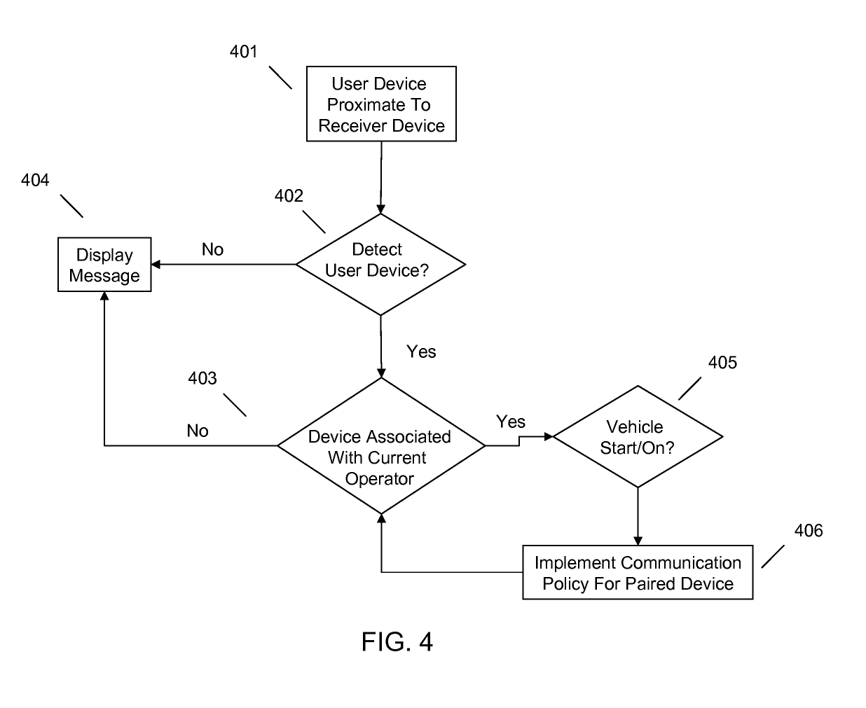

Turning to FIG. 4, an example of managing a user device in an operator specific manner is illustrated. A user device, e.g., device 303 of FIG. 3, is proximately located to the receiver device, e.g., 304 of FIG. 3, at 401. For example, a user of user device 303 may tap the device on the dashboard location including the receiver device 304. This permits the receiver device and associated circuitry to detect the user device (e.g., using NFC, short-range wireless communication such as BLUETOOTH technology, etc.) at 402. If no user device is detected at 402, a message may be displayed (or otherwise presented, e.g., an audible message or indication) at 404, for example requesting that a user device be presented for detection.

If a user device is associated with a current operator, e.g., via detection of a device (or a particular device) in proximity to the receiver device, e.g., via signal strength distinguishing a device from other device(s), etc., as determined at 403, an embodiment may permit the vehicle to be started. If the device is not associated with a current operator of the vehicle, e.g., using one of the example mechanisms described herein, an embodiment may again display a message at 404 or otherwise indicate a requirement for a user device.

In an embodiment, this requirement for a user device (or an appropriate, e.g., pre-authorized user device of a known operator) may be a strict requirement. Thus, unless an appropriate user device is detected and associated with a current operator (including associating the device with a known, pre-authorized operator), an embodiment may prevent the vehicle from being started, i.e., similar to use of a user mobile device as a key. In an alternative embodiment, this requirement for a user device may be less strict. For example, if a user device is not detected, etc., an embodiment may permit the vehicle to be started, but limit vehicle and/or device operation in another way. For example, an embodiment may allow the vehicle to be started and operated in the absence of a user device but thereafter limit all device communication within the vehicle. As another example, an embodiment may allow any user device (i.e., not a particular, known user device) to be detected, or several devices to be detected, and permit the vehicle to be started/operated, but implement limited communications for the device associated with the operator, e.g., based on location. Thus, there may not be a requirement for a particular user device to start the vehicle.

If the user device detected is associated with the current operator, e.g., via its physical location, its device ID, both, or other current operator identification mechanism, an embodiment may automatically limit that user device's communication capabilities (e.g., disabling an SMS texting application's functionality) or await further action(s) or event(s) prior to doing so. Thus, if the current operator device is automatically limited in its communications capability, other actions may not be performed (e.g., requiring the device as a key). For example, the user device of the current operator may be limited in its communication capabilities and the current operator may start the car with a traditional key.

In the alternative, limiting of the current operator's user device communication capabilities may be delayed. For example, as illustrated in FIG. 4, an embodiment may await an event, e.g., a determination that the vehicle has been started (ignition switched on or button engaged), as determined at 405, prior to implementing a communication policy for the user device of the current operator at 406. This permits the user of the device associated with the current operator of the vehicle to continue to use communication capabilities (e.g., according to a communication policy) while it remains safe for the current operator to do so, e.g., prior to the vehicle being started, prior to the vehicle being moved, etc., such as in a parked car. Other events than starting of the vehicle may thus server as the trigger and be detected at 405, e.g., that the vehicle has been placed in drive or that the vehicle is moving (forward or reverse direction), prior to implementing a communication policy for the user device of the current operator at 406.

Embodiments therefore permit the current operator's device to be limited or disabled selectively while permitting other devices (e.g., passenger device(s)) to be utilized. The various embodiments may have more or less strict requirements, e.g., according to user preferences or user history of interaction, in order to increase or decrease device communication capabilities flexibly to suit particular users' needs.

For example, an embodiment may be set to a strict communications policy such that a particular user device, e.g., via a dashboard interface with an on-board computer or via a mobile phone having authority to change user settings. For example, a user may apply a setting such that a particular user device is required, e.g., parent's mobile phone, to start the car and the user device is thereafter partially disabled (e.g., text messaging only is disabled). Alternatively, an embodiment may implement less strict requirements to suit other users' needs. For example, an embodiment may require only that a suitable device (e.g., one of a plurality of family members) be located proximate to the receiver device in order to start the vehicle, with that device's communications capabilities thereafter being disabled (e.g., device screen locked, display powered off, SMS-text application disabled, device placed into low power mode, etc.). It should be noted here that there are many ways in which a device's communication capabilities may be limited or disabled, in whole or in part.

It should be noted as well that the initial communications policy chosen or applied may be modified dynamically to suit particular use cases. For example, if a first user device is utilized to start the vehicle and thereafter has its communication capabilities limited or eliminated, it may thereafter have its communications capabilities re-enabled. For example, if the first device is re-located to another part of the interior, e.g., a passenger portion of the interior, for example as detected by signal strength, etc., the device may have some or all of its communications capabilities re-enabled. This re-enablement may be dependent on the user device not being re-located to the operator's zone or area of the vehicle′ interior.

In terms of how a communications policy is implemented for limiting some or all of a user device's capabilities once a user device has been associated with a current operator, a variety of mechanisms may be utilized. For example, in an embodiment a message is transmitted, e.g., via receiver device 304 or other suitable communication component, e.g., of the vehicle, in order to instruct the user device, e.g., of the communications policy. This message may be formatted in a variety of ways. For example, it may be a proprietary message delivered to a proprietary application running on the user device, where the application running on the user device implements various communication policy settings (e.g., powering off certain components, e.g., placing the user device into airplane mode, low power mode, locking the screen display, powering off particular radios, etc.). Other mechanisms and message formats may be utilized.

As may be appreciated from the foregoing, various embodiments allow for operator specific management of a user device located within the interior of a vehicle. Thus, a user operating the vehicle may have his or her device temporarily disabled (partially or wholly) while other users are not so limited. Such specific limitations therefore facilitate safety for the operation of the vehicle while not being viewed as overly burdensome for the other occupants of the vehicle.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, in a vehicle, a user device is proximate to a receiver device of the vehicle;
determining, using a processor, that the user device is associated with a current operator of the vehicle;
permitting access to the vehicle; and
disabling a communication capability of the user device.

2. The method of claim 1, wherein the determining comprises using a proximity metric to associate the user device with a current operator of the vehicle.

3. The method of claim 2, wherein the proximity metric is wireless signal strength detected by the receiver device.

4. The method of claim 1, wherein the determining comprises associating an identifier of the user device with a known operator identifier.

5. The method of claim 1, wherein the detecting comprises using near field communication between the user device and the receiver device.

6. The method of claim 1, wherein the detecting comprises using short range wireless communication between the user device and the receiver device.

7. The method of claim 1, wherein the communication capability of the user device is SMS text messaging capability.

8. The method of claim 1, further comprising providing an indication that the communication capability of the user device has been disabled.

9. The method of claim 1, further comprising re-enabling the communication capability of the user device responsive to an event.

10. The method of claim 9, wherein the event is selected from the group of events consisting of stopping the vehicle and determining that the user device is no longer associated with the current operator of the vehicle.

11. The method of claim 1, wherein to permit access to the vehicle includes one or more of permitting the user device to unlock a door of the vehicle and permitting the user device to start the vehicle.

12. A vehicle, comprising:
a vehicle body;
a motor to propel the vehicle body;
a receiver device disposed within the vehicle body;
a processor; and
a memory device storing instructions executable by the processor to:
detect a user device is proximate to the receiver device;
determine that the user device is associated with a current operator of the vehicle;
permit access to the vehicle; and
disable a communication capability of the user device.

13. The vehicle of claim 12, wherein to determine comprises using a proximity metric to associate the user device with a current operator of the vehicle.

14. The vehicle of claim 13, wherein the proximity metric is wireless signal strength detected by the receiver device.

15. The vehicle of claim 12, wherein to determine comprises associating an identifier of the user device with a known operator identifier.

16. The vehicle of claim 12, wherein to detect comprises using near field communication between the user device and the receiver device.

17. The vehicle of claim 12, wherein to detect comprises using short range wireless communication between the user device and the receiver device.

18. The vehicle of claim 12, wherein the communication capability of the user device is SMS text messaging capability.

19. The vehicle of claim 11, wherein the instructions are further executable by the processor to re-enable the communication capability of the user device responsive to an event, wherein the event is selected from the group of events consisting of stopping the vehicle and determining that the user device is no longer associated with the current operator of the vehicle.

20. A program product, comprising:
a storage medium comprising computer readable program code, the computer readable program code comprising:
computer readable program code configured to detect, in a vehicle, a user device is proximate to a receiver device of the vehicle;
computer readable program code configured to determine, using a processor, that the user device is associated with a current operator of the vehicle;
computer readable program code configured to permit access to the vehicle; and
computer readable program code configured to disable a communication capability of the user device.
